(19) United States
(12) Patent Application Publication
(10) Pub. No.: US 2003/0039232 A1
(43) Pub. Date: Feb. 27, 2003

(54) Method of sending a multicast message in such as a GPRS/UMTS network, and a mobile telecommunications network

(76) Inventors: Alessio Casati, Wiltshire (GB); Sudeep Kumar Palat, Wiltshire (GB)

Correspondence Address: Docket Administrator (Room 3J-219), Lucent Technologies Inc., 101 Crawfords Corner Road, Holmdel, NJ, 07733-3030, US

(21) Appl. No.: 10/223,544

(22) Filed: Aug. 19, 2002

(30) Foreign Application Priority Data
Aug. 22, 2001 (GB) 0120421.3
Nov. 21, 2001 (EP) 01309799.3

(51) Int. Cl. H04B 7/212; H04L 12/56

(52) U.S. Cl. 370/337; 370/347; 370/349; 370/401

(57) ABSTRACT

A method of sending a multicast message to a plurality of mobile stations in a multicast group is provided. The method involves sending to an access point of a mobile telecommunications network a control message to assign a mobile station to a multicast group. The multicast message is sent to each of one or more access points, each having one or more associated mobile stations in the multicast group. Each access point forwards the multicast message to its associated one or more mobile stations in the multicast group.

### CROSS REFERENCE TO RELATED APPLICATION

This application claims priority of Great Britain Provisional Application No. 0120421.3 filed on Aug. 22, 2001 and European Application No. 01309799.3 filed Nov. 21, 2001.

### TECHNICAL FIELD

The present invention relates to a method of sending a multicast message to a plurality of mobile stations in a multicast group, and to a mobile telecommunications network comprising a multicast server.

### BACKGROUND OF THE INVENTION

There is a requirement in Universal Mobile Telecommunications Systems (UMTS) standards to support multicast services. The known solution is for the gateway general packet radio system (GPRS) support node (GGSN), which is the point of entry to the UMTS network, to duplicate data streams so as to send data over point-to-point links over the UMTS network. Using point-to-point links over the UMTS network is inefficient and uses additional resources. It uses not only network resources but also scarce radio resources. This is because the multicast data is sent over the dedicated point-to-point links. If there are several users in a cell, the same information is sent over several channels, one for each user.

### SUMMARY OF THE INVENTION

The present invention provides a method of sending a multicast message to a plurality of mobile stations. The invention involves sending to an access point of a mobile telecommunications network a control message to assign a mobile station to a multicast group. The multicast message is sent to the (or each) access point having one or more associated mobile stations in the multicast group. The (or each) access point forwards the multicast message to its associated one or more mobile stations in the multicast group. Furthermore, the multicast message can be an Internet Protocol (IP) multicast message. Furthermore the multicast message can be multicast data.

One advantage of the invention in at least some embodiments is efficient use of core network resources, achieved by sending only one data stream to the access network for all multicast users in the access network. Advantageously, data can thus be sent to the relevant radio networks without duplicating data over the core network. Thus, multicast data can be sent down one path over the core network to the radio network. This avoids wastage of network resources.

The use of normal IP multicast protocols is possible. Tailor-made applications for the mobile network are not an absolute requirement. This makes it easy for the same terminal to be used in the same way in a fixed IP network or wireless local area network (WLAN) scenario.

In some embodiments, the control message is sent from an anchor point, which is a gateway GPRS support node (GGSN), upon receipt of a group membership instruction from the mobile station. The instruction is preferably an internet group management protocol (IGMP) frame.

In some embodiments, the network is a UMTS core network and the (or each) access point is a radio network controller. It is advantageous in this regard to adapt IP multicast protocol to the UMTS wireless network. A mapping is provided between the IP addresses and UMTS addresses to maximise re-use of existing UMTS protocols, and enable joining (and leaving) IP multicast groups in UMTS networks to use IETF standards internet group management protocol (IGMP) messages.

In some embodiments, the mobile station is assigned to a multicast group by sending signalling comprising a multicast access point name (APN) as part of a create packet data protocol (PDP) context set-up.

Preferably the control message indicates that the access point to a mobile station is to join a multicast group so as to receive and forward multicast messages to its associated mobile station(s) in the multicast group. This is particularly efficient for users in the home network.

Alternatively, the control message indicates that a radio access bearer is to be set up for multicast messaging to the mobile station. Preferably the anchor point is operative to set up GPRS tunnelling protocol (GTP) tunnels for the multicast group between the anchor point and the signalling GPRS support node (SGSN) and between the SGSN and the access point, or to add a mobile station identifier to a membership list for the group if the GTP tunnels already exist. This approach is well suited to handle roaming users.

Preferably, upon a mobile station moving to the control of a different access point, associated multicast group membership information is forwarded to the new access point. Preferred embodiments thus advantageously handle mobility within a UMTS network.

In other embodiments, the network is a second generation GPRS core network and the access point is a signalling GPRS support node (SGSN).

The present invention also provides a mobile telecommunications network comprising a multicast server operative to control the sending, to an access point of the telecommunications network, of a control message to assign a mobile station to a multicast group, and operative to control the sending of a multicast message to the (or each) access point having one or more associated mobile stations assigned to the multicast group. The (or each) access point is operative to forward the multicast message to its associated one or more mobile stations assigned to the multicast group.

### BRIEF DESCRIPTION OF THE DRAWINGS

A preferred embodiment of the present invention will now be described by way of example and with reference to the drawings, in which:

FIG. 1 is a diagrammatic illustration of a preferred UMTS/GPRS network.

### DETAILED DESCRIPTION

The support of IP multicast transmissions in GPRS/UMTS core networks can be generalised to the problem of how to support multicast in a hierarchical tunnel-based mobility support system. A hierarchical tunnel based mobility support system uses compulsory tunnels from an access point that can be rearranged hop-by-hop up to an anchor point. The access point is exemplarily the base station controller (BSC) or radio network controller (RNC), or another wireless or wireline access network termination node. No assumption is here made on the nature of the access network, nor on its ability to deliver multicast traffic using native multicast channels or replication over unicast point-to-point channels.

The user IP packets, which include the internet group management protocol (IGMP) messages, are carried via tunnels all the way from the access point to the anchor point (and vice versa). So, the problem arises that the IP connectivity between the anchor point to the access point might not support multicast, or that the IP multicast address might be administratively scoped—that is, that the multicast stream available at the anchor point of attachment to the internet might not be accessible at the visited location (namely at the access point).

Two solutions to the problem are:

A) The use of some messages from the anchor point to the access point that trigger the access point to join a multicast group, multicast data being available at all possible access points.

B) The creation of point-to-multipoint tunnels that distribute multicast stream to the locations where mobile users are. In this case multicast data is only available at the anchor point and is sent down these tunnels to the access point.

We here assume that internet group management protocol IGMPv2 is used to report multicast membership.

Access Points and intermediate nodes keep their states related to which was the upper hierarchical level of the protocol stack requesting them to join a multicast group. Thus, they may enquire periodically about which of the list of multicast groups are still active, if they have not been used for a while. The anchor point is expected to keep its state up to date.

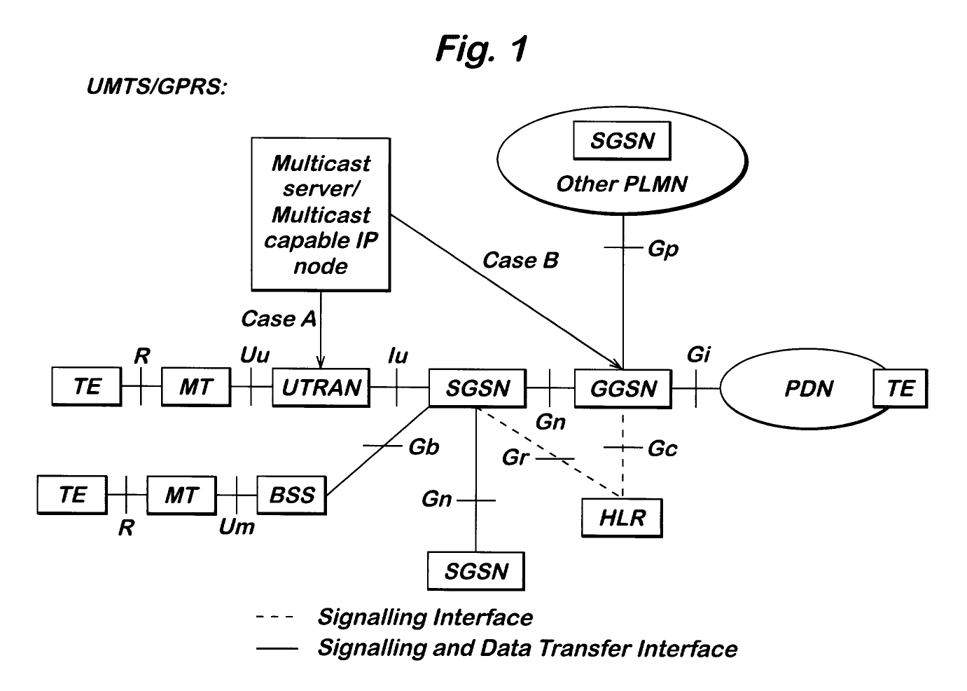

FIG. 1 shows the UMTS/GPRS network architecture. The new network element is the Multicast Server/IP-multicast-capable IP node. In FIG. 1, MT denotes the mobile termination of the core network and TE denotes the mobile station.

The radio network controller (RNC) is the access point for, e.g., a UMTS network in which the signalling protocol used at the hierarchical level associated with the anchor point (e.g., the gateway GPRS support node, abbreviated “GGSN”) is GTP-C, and the protocol at the next-lower hierarchical level is RANAP between the serving GPRS support node (SGSN) and the RNC. “GTP” stands for GPRS tunnelling protocol “GTP-C” stands for GTP control plane. “RANAP” stands for radio access network application part.

For user data, the GTP user plane (GTP-U) is used from the GGSN to the RNC. Alternatively, for second generation 2G GPRS functionality the access point is the serving GPRS support node (SGSN).

For a mobile station specialised for UMTS/GPRS use only, it is possible to define a multicast access point name (APN), for which no IP address assignment occurs. In that case, the only purpose of the Create packet data protocol (PDP) context procedure is to signal to the GGSN that the mobile station has joined a multicast group. Then, one of the options A or B above is used to manage multicast content delivery to the access point. This provides the benefit that there is no need to send specialised IP packets for multicast group management over the air interface (Uu, Um).

Alternatively, the mobile node (MN) joins a multicast group “G” by sending an unsolicited internet group management protocol IGMPv2 membership report. The procedure in the GGSN then depends on which of the two cases given above is used.

Case A is more suitable for intra-public land mobile network (intra-PLMN) multicasts, whereas case B handles multicasts to roaming users better. Of course, a packet data protocol (PDP) context must be set up to send internet group management protocol (IGMP) packets and must be maintained when the user is expecting multicast data.

Case A: Triggering the Access Point to Join a Multicast Group

The anchor point, GGSN in this case, upon detection of the internet group management protocol (IGMP) message, sends towards the access point serving the mobile node (or towards a hierarchically lower anchor point serving the mobile node, which will then forward this appropriately, until the Access point is reached) a “join multicast group G for mobile node U” message.

In UMTS, this involves: GTP messages between the gateway GGSN and the signalling GPRS support node (SGSN), and RANAP messages between the SGSN and the RNC. The GGSN knows which SGSN the user is in because there exists at least one PDP context for the user at this GGSN, on which it detected the internet group management protocol (IGMP) message. Hence, no home location register (HLR) look-up is expected. The GGSN also does the mapping between the IP address and the international mobile subscriber identity (IMSI) for each internal user within the GPRS network. It similarly identifies the IMSI without having to use static IP addresses.

When the message is received at the access point (in UMTS, for example, an RNC), the access point issues an unsolicited internet group management protocol IGMPv2 membership report to the next-hop router, which is expected to be multicast-capable. This facilitates delivery of the multicast data to the access point (e.g., RNC for UMTS).

When the mobile leaves the group without tearing down all the PDP contexts for the active address, using IGMPv2 frames detected at the anchor point, the anchor point repeats the process used for joining the mobile so as to remove the mobile from the multicast group. A similar procedure is used if the mobile node (MN) tears down all the sessions associated with this GGSN; one session is expected to be active at all times to receive multicast data.

Case B: Creating Point to Point Tunnels

In this case the anchor point receives an IGMPv2 message, and sends a message “create Multicast bearer for group ‘G’ for mobile node U” down the hierarchy to the access point where the mobile joined the group. Level by hierarchical level, each node traversed by such a message, up to and including the Access Point where the mobile node (MN) is, establishes a tunnel with the node immediately above it in the hierarchy, if such a tunnel did not exist for group ‘G’. If such a tunnel existed, the tunnel is reused, but the message is forwarded to the node at the next-lower hierarchical level towards the Access point where the mobile node is.

In UMTS, the anchor point (i.e., the GGSN) initiates the set up of GTP tunnels to the RNC. Note that in the case of either UMTS or GPRS, the option to indicate a request to the mobile node (MN) with the MN initiating the set up of the tunnels/joining the group is also possible. The quality of service (QoS) for the packet data protocol (PDP) is also set up at that time. The QoS required for the session may be pre-configured in the universal subscriber identity module (USIM) or the GGSN. Alternatively, it could be defined by the application, if an appropriate way existed for the applications to communicate with the mobile termination (MT) and GGSN.

As part of this PDP context set-up, a special GTP tunnel is set up for this group between the gateway GPRS support node (GGSN) and the signalling GPRS support node (SGSN). If a GTP tunnel already exists for this group between the GGSN and the SGSN, the user's international mobile subscriber identity (IMSI) is added to the group list. A pseudo-IMSI can be associated with this PDP context to minimise changes to existing procedures.

Handling the Radio (Iu) Interface: Radio Access Bearer (RAB) Creation, Management and Source Radio Network Controller (SRNC) Relocation

The signalling GPRS support node (SGSN) is responsible for setting up of the Iu interface to the radio network controller (RNC). For case A, the RNC need only be given an indication of the user joining the multicast group. This can be done using a radio access network application part (RANAP) message.

For the SGSN to set up a radio access bearer (RAB) towards all the radio network controllers (RNCs) where users are located, the following applies:

When a new user joins the group, and if no RAB exists towards the RNC for this multicast group, a RAB establishment procedure is used to create the RAB. The IMSI of the user(s) belonging to this group must be made available to the RNC.

If an RAB already exists towards the RNC for this multicast group, the RAB is modified to include the new user's IMSI.

The RAB establishment procedure triggers the radio network controller (RNC) to request multicast data from the anchor point.

For Case B, it is the responsibility of the signalling GPRS support node (SGSN) to duplicate the packet and send it on each of the RABs. Note that this can be done at the GPRS tunnelling protocol (GTP) level without having to look at the user IP packet.

User Mobility

When a mobile moves, the multicast groups status associated with it is relocated to the new access point. The old access point may leave the multicast group G if the mobile node (MN) was the only one that had joined a multicast group, or it may keep the membership active if other users were members of multicast group G at the access point.

When a user moves between serving GPRS support nodes (SGSNs), the user context moved between the SGSNs includes the groups to which the user belongs. This information is carried in the appropriate inter-serving SGSN GTP mobility messages depending on the user state—either idle or Iu-connected. An update packet data protocol (PDP) context is initiated by the new SGSN towards the gateway GPRS support node (GGSN) to update the serving SGSN to which the user belongs.

Upon source radio network controller (SRNC) relocation, the groups to which the user belongs are passed by the serving GPRS support node (SGSN) to the transmit radio network controller (TRNC). If the new radio network controller (RNC) does not receive multicast data for such a group, a new radio access bearer (RAB) must be created if none exist towards the RNC (for Case B), or else the RNC must send an unsolicited internet group management protocol IGMPv2 membership report to the next-hop router (for case A).

We claim:

1. A method of sending a multicast message to a plurality of mobile stations, comprising: sending to an access point of a mobile telecommunications network a control message to assign a mobile station to a multicast group; and sending the multicast message to the or each access point having one or more associated mobile stations in the multicast group wherein the, or each said access point forwards the multicast message to its associated one or more mobile stations in the multicast group.

2. A method of sending a multicast message according to claim 1, in which the control message is sent from an anchor point which is a gateway GPRS support node upon receipt of a group membership instruction from the mobile station.

3. A method of sending a multicast message according to claim 2, in which the anchor point is operative to set up GPRS tunnelling protocol (GTP) tunnels for the multicast group between the anchor point and a signalling GPRS support node (SGSN), and between the SGSN and the access point, or to add a mobile station identifier to a membership list for the group if the GTP tunnels already exist.

4. A method of sending a multicast message according to claim 1, in which the network is a UMTS core network and the or each access point is a radio network controller.

5. A method of sending a multicast message according to claim 1, in which the mobile station is assigned to a multicast group by sending signalling comprising a multicast access point name as part of a create packet data protocol context set-up.

6. A method of sending a multicast message according to claim 1, in which the control message indicates that the access point to a mobile station is to join a multicast group so as to receive and forward multicast messages to its associated mobile station(s) in the multicast group.

7. A method of sending a multicast message according to claim 1, in which the network is a UMTS core network, and the or each access point is a radio network controller; and the control message is sent from an anchor point which is a gateway GPRS support node upon receipt of a group membership instruction from the mobile station; and the control message indicates that a radio access bearer is to be set up for multicast messaging to the mobile station.

8. A method of sending a multicast message according to claim 1, in which upon a mobile station moving to the control of a new access point, associated multicast group membership information is forwarded to the new access point.

9. A method of sending a multicast message according to claim 1, in which the network is a second generation GPRS core network, and the access point is a signalling GPRS support node.

10. A mobile telecommunications network comprising a multicast server operative to control the sending to an access point of the telecommunications network of a control message to assign a mobile station to a multicast group, and operative to control the sending of a multicast message to each of one or more access points, the or each access point having one or more associated mobile stations assigned to the multicast group, and the or each access point being operative to forward the multicast message to its associated one or more mobile stations assigned to the multicast group.
